(19) United States
(12) Patent Application Publication
(10) Pub. No.: US 2025/0024356 A1
(43) Pub. Date: Jan. 16, 2025

(54) METHOD AND DEVICE FOR PROVIDING CAPABILITY RESTRICTION INFORMATION OF MUSIM TERMINAL IN NEXT-GENERATION MOBILE COMMUNICATION SYSTEM

(71) Applicant: Samsung Electronics Co., Ltd., Suwon-si (KR)

(72) Inventor: Sangyeob JUNG, Suwon-si (KR)

(21) Appl. No.: 18/763,417

(22) Filed: Jul. 3, 2024

(30) Foreign Application Priority Data
Jul. 14, 2023 (KR) 10-2023-0091639

(51) Int. Cl. H04W 48/16; H04W 88/06

(52) U.S. Cl. CPC H04W 48/16; H04W 88/06

(57) ABSTRACT

The disclosure relates to a 5G or 6G communication system for supporting a higher data transmission rate. A method performed by a user equipment (UE) in a wireless communication system is provided. The method includes receiving, from a base station, system information block 1 (SIB1), determining whether the UE has a temporary capability restriction, and in case that the SIB1 comprises information that allows to send an indicator related to the temporary capability restriction, and the UE has the temporary capability restriction, transmitting, to the base station, a first radio resource control (RRC) message including the indicator, wherein the indicator indicates temporary capability restriction associated with multi universal subscriber identity module (MUSIM) operation.

### CROSS-REFERENCE TO RELATED APPLICATION(S)

This application is based on and claims priority under 35 U.S.C. § 119 (a) of a Korean patent application number 10-2023-0091639, filed on Jul. 14, 2023, in the Korean Intellectual Property Office, the disclosure of which is incorporated by reference herein in its entirety.

### BACKGROUND

### 1. Field

The disclosure relates to operations of a terminal and a base station in a mobile communication system. More particularly, the disclosure relates to a method and a device for preemptively providing capability restriction information of a multi-universal subscriber identity module (MUSIM) terminal to a base station in a next-generation mobile communication system.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide improved operations of a terminal and a base station in a mobile communication system.

Another aspect of the disclosure is to provide a method and a device for preemptively providing capability restriction information of an MUSIM terminal to a base station in a next-generation mobile communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, system information block 1 (SIB1), determining whether the UE has a temporary capability restriction and in case that the SIB1 comprises information that allows to send an indicator related to the temporary capability restriction, and the UE has the temporary capability restriction, transmitting, to the base station, a first radio resource control (RRC) message including the indicator, wherein the indicator indicates temporary capability restriction associated with multi universal subscriber identity module (MUSIM) operation.

In accordance with another aspect of the disclosure, a method performed by a base station in a wireless communication system is provided. The method includes broadcasting system information block 1 (SIB1), and in case that the SIB1 includes information that allows to send an indicator related to a temporary capability restriction, and the temporary capability restriction exists for a user equipment (UE), receiving a first radio resource control (RRC) message including the indicator from the UE, wherein the indicator indicates temporary capability restriction associated with multi universal subscriber identity module (MUSIM) operation.

In accordance with another aspect of the disclosure, a user equipment (UE) in a wireless communication system is provided. The UE includes a transceiver and a controller configured to receive, from a base station, system information block 1 (SIB1), determine whether the UE has a temporary capability restriction, and in case that the SIB1 comprises information that allows to send an indicator related to the temporary capability restriction, and the UE has the temporary capability restriction, transmit, to the base station, a first radio resource control (RRC) message including the indicator, wherein the indicator indicates temporary capability restriction associated with multi universal subscriber identity module (MUSIM) operation.

In accordance with another aspect of the disclosure, a base station in a wireless communication system is provided. The base station includes a transceiver and a controller configured to broadcast system information block 1 (SIB1), and in case that the SIB1 includes information that allows to send an indicator related to a temporary capability restriction, and the temporary capability restriction exists for a user equipment (UE), receive a first radio resource control (RRC) message including the indicator from the UE, wherein the indicator indicates temporary capability restriction associated with multi universal subscriber identity module (MUSIM) operation.

Various embodiments of the disclosure may provide improved operations of a terminal and a base station in a mobile communication system.

In addition, various embodiments of the disclosure may provide a method and a device for preemptively providing capability restriction information of a MUSIM terminal to a base station in a next-generation mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of an LTE system according to an embodiment of the disclosure;

FIG. 2 illustrates a radio protocol structure of an LTE system according to an embodiment of the disclosure;

FIG. 3 illustrates a structure of a next-generation mobile communication system according to an embodiment of the disclosure;

FIG. 4 illustrates a radio protocol structure of a next-generation mobile communication system according to an embodiment of the disclosure;

FIG. 5 is a flowchart in which a UE for supporting multiple universal subscriber identity modules (USIMs) (multi-USIM UE, hereinafter referred to as a MUSIM UE) requests/provides temporary UE capability information restrictions from/to a base station, according to an embodiment of the disclosure;

FIG. 6 is a flowchart in which a UE (MUSIM UE) for supporting multiple USIMs requests/provides temporary UE capability information restrictions from/to a base station, according to an embodiment of the disclosure;

FIG. 7 is a flowchart in which a UE (MUSIM UE) for supporting multiple USIMs requests/provides temporary UE capability information restrictions from/to a base station, according to an embodiment of the disclosure;

FIG. 8 is a flowchart in which a UE (MUSIM UE) for supporting multiple USIMs requests/provides temporary UE capability information restrictions from/to a base station, according to an embodiment of the disclosure;

FIG. 9 illustrates a configuration of a UE according to an embodiment of the disclosure; and

FIG. 10 illustrates a configuration of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the term “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card.

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing a communication function. Furthermore, the embodiments of the disclosure as described below may also be applied to other communication systems having similar technical backgrounds or channel types to the embodiments of the disclosure. In addition, based on determinations by those skilled in the art, the embodiments of the disclosure may also be applied to other communication systems through some modifications without significantly departing from the scope of the disclosure. Examples of such communication systems may include 5th generation mobile communication technologies (5G, new radio, and NR) developed beyond LTE-advanced (LTE-A), and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, some of terms and names defined in the 3rd generation partnership project (3GPP) long term evolution (LTE) standards and/or 3GPP new radio (NR) standards may be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. That is, a base station described as “eNB” may indicate “gNB”. In various embodiments of the disclosure, all of an eNB, a gNB, a network (NW) may be defined as a base station.

In various embodiments of the disclosure, a UE may refer to a MUSIM UE, and the MUSIM UE may refer to a UE for supporting an MUSIM function. In addition, the terms “UE” and “MUSIM UE” may be interchangeably used in various embodiments of the disclosure. In addition, in the disclosure, in a UE including multiple USIMs, a UE using each USIM may also be referred to as a UE. For example, when the MUSIM UE includes USIM 1, USIM 2, . . . , and USIM n, a UE using USIM 1 may be referred to as a first UE, a UE using USIM 2 may be referred to as a second UE, and a UE using USIM n may be referred to as an n-th UE.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

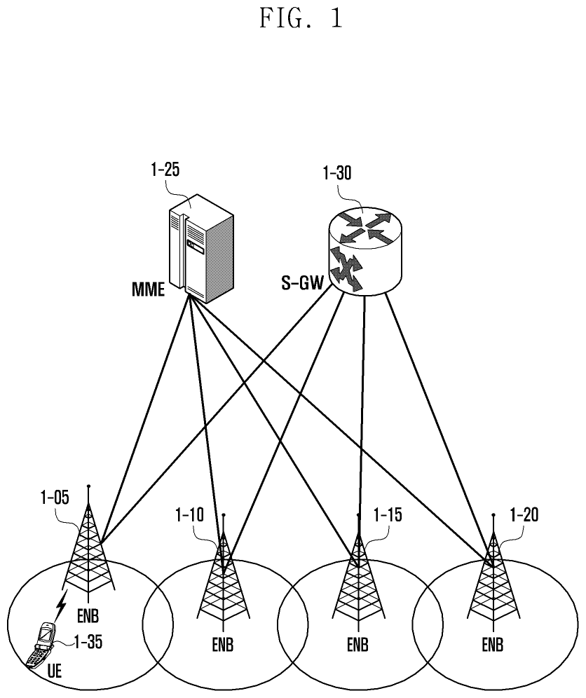

FIG. 1 illustrates a structure of an LTE system according to an embodiment of the disclosure.

Referring to FIG. 1, as illustrated therein, a radio access network of an LTE system includes next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 accesses an external network through the ENBs 1-05, 1-10, 1-15, and 1-20 and the S-GW 1-30.

In FIG. 1, the ENBs 1-05, 1-10, 1-15, and 1-20 correspond to conventional node Bs of a universal mobile telecommunication system (UMTS). The ENBs are connected to the UE 1-35 through a radio channel, and perform more complicated roles than the conventional node Bs. In the LTE system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is required, and the ENBs 1-05, 1-10, 1-15, and 1-20 serve as the device. In general, one ENB controls multiple cells. For example, in order to implement a transfer rate of 100 Mbps, the LTE system uses orthogonal frequency division multiplexing (hereinafter referred to as OFDM) as a radio access technology in a bandwidth of, for example, 20 MHz. Furthermore, the LTE system employs an adaptive modulation & coding (hereinafter referred to as AMC) scheme for determining a modulation scheme and a channel coding rate according to a channel state of a UE. The S-GW 1-30 is a device that provides a data bearer, and generates or removes a data bearer under the control of the MME 1-25. The MME 1-25 is a device responsible for various control functions as well as a mobility management function for a UE, and is connected to multiple base stations.

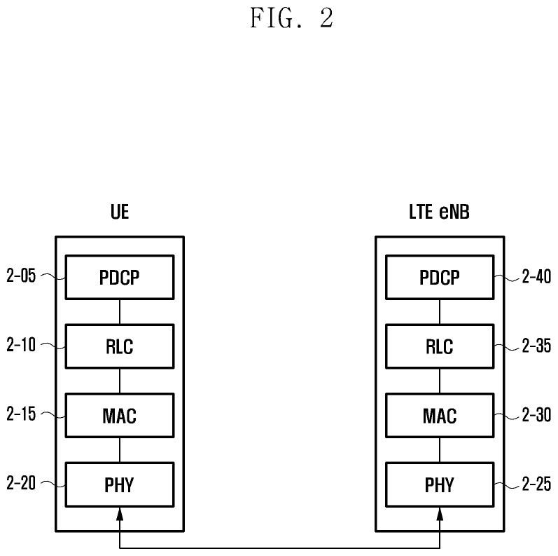

FIG. 2 illustrates a radio protocol structure of an LTE system according to an embodiment of the disclosure.

Referring to FIG. 2, a radio protocol of an LTE system includes a packet data convergence protocol (PDCP) 2-05 or 2-40, a radio link control (RLC) 2-10 or 2-35, and a medium access control (MAC) 2-15 or 2-30 in each of a UE and an ENB. The packet data convergence protocol (PDCP) 2-05 or 2-40 is responsible for operations such as IP header compression/reconstruction. The main functions of the PDCP are summarized as follows.
Header compression and decompression: robust header compression (ROHC) only
Transfer of user data
In-sequence delivery of upper layer protocol data units (PDUs) at PDCP re-establishment procedure for RLC AM
For split bearers in DC (only support for RLC acknowledged mode (AM)): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (hereinafter referred to as RLC) 2-10 or 2-35 reconfigures a PDCP protocol data unit (PDU) into an appropriate size to perform an automatic repeat request (ARQ) operation, etc. The main functions of the RLC are summarized as follows.
Transfer of upper layer PDUs
Error Correction through ARQ (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 is connected to several RLC layer devices configured in a single terminal, and multiplexes RLC PDUs into a MAC PDU and demultiplexes a MAC PDU into RLC PDUs. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid ARQ (HARQ)
Priority handling between logical channels of one UE
Priority handling between UEs by means of dynamic scheduling
MBMS service identification
Transport format selection
Padding

A physical layer 2-20 or 2-25 performs operations of channel-coding and modulating upper layer data, thereby obtaining OFDM symbols, and delivering the same through a radio channel, or demodulating OFDM symbols received through the radio channel, channel-decoding the same, and delivering the same to the upper layer.

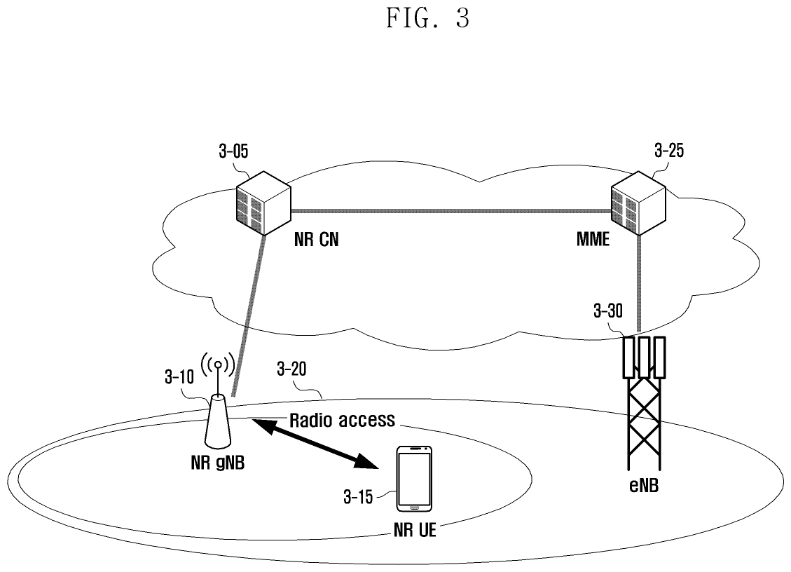

FIG. 3 illustrates a structure of a next-generation mobile communication system according to an embodiment of the disclosure.

Referring to FIG. 3, an NR gNB 3-10 corresponds to an evolved node B (eNB) of a conventional LTE system. The NR gNB is connected to an NR UE 3-15 through a radio channel 3-20 and may provide outstanding services as compared to a conventional node B. In a next-generation mobile communication system, since all user traffic is serviced through a shared channel, a device that collects state information, such as buffer statuses, available transmit power states, and channel states of UEs, and performs scheduling accordingly is required, and the NR gNB 3-10 serves as the device. In general, one NR gNB controls multiple cells. In order to implement ultrahigh-speed data transfer beyond the current LTE, the next-generation mobile communication system may have a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE. An NR CN 3-05 performs functions such as mobility support, bearer configuration, and quality of service (QOS) configuration. The NR CN 3-05 is a device responsible for various control functions as well as a mobility management function for a UE, and is connected to multiple base stations. In addition, the next-generation mobile communication system may interwork with the existing LTE system, and the NR CN 3-05 is connected to an MME 3-25 via a network interface. An MME 3-25 is connected to an eNB 3-30 that is a conventional base station.

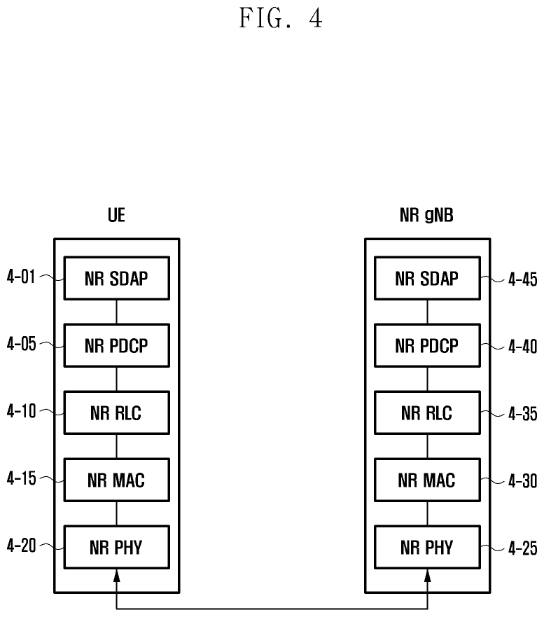

FIG. 4 illustrates a radio protocol structure of a next-generation mobile communication system according to an embodiment of the disclosure.

Referring to FIG. 4, a radio protocol of a next-generation mobile communication system includes an NR service data adaptation protocol (SDAP) 4-01 or 4-45, an NR PDCP 4-05 or 4-40, an NR RLC 4-10 or 4-35, and an NR MAC 4-15 or 4-30 in each of a UE and an NR base station.

The main functions of the NR SDAP 4-01 or 4-45 may include some of functions below.
Transfer of user plane data
Mapping between a QoS flow and a data radio bearer (DRB) for both
DL and UL
Marking QoS flow ID in both DL and UL packets
Reflective QoS flow to DRB mapping for the UL SDAP PDUS

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QOS reflection configuration 1-bit indicator (NAS reflective QoS) and the access stratum (AS) QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 4-05 or 4-40 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDU received from a lower layer in an order based on PDCP sequence numbers (SNs), and may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC 4-10 or 4-35 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device refers to a function of transferring RLC SDUs received from a lower layer to an upper layer in sequence, and may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to an upper layer, may include a function of, although there is a lost RLC SDU, if a predetermined timer has expired, sequentially transferring, to an upper layer, all the RLC SDUs received before the timer is started, or may include a function of, although there is a lost RLC SDU, if a predetermined timer has expired, sequentially transferring all the RLC SDUs received up to the current, to an upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of instantly delivering RLC SDUs received from the lower layer to the upper layer regardless of the order, may include a function of, if multiple RLC SDUs received, into which one original RLC SDU has been segmented, are received, reassembling and delivering the same, and may include a function of storing the RLC SN or PDCP SN of received RLC PDUs, and recording RLC PDUs lost as a result of reordering.

The NR MAC 14-15 or 4-30 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 4-20 or 4-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

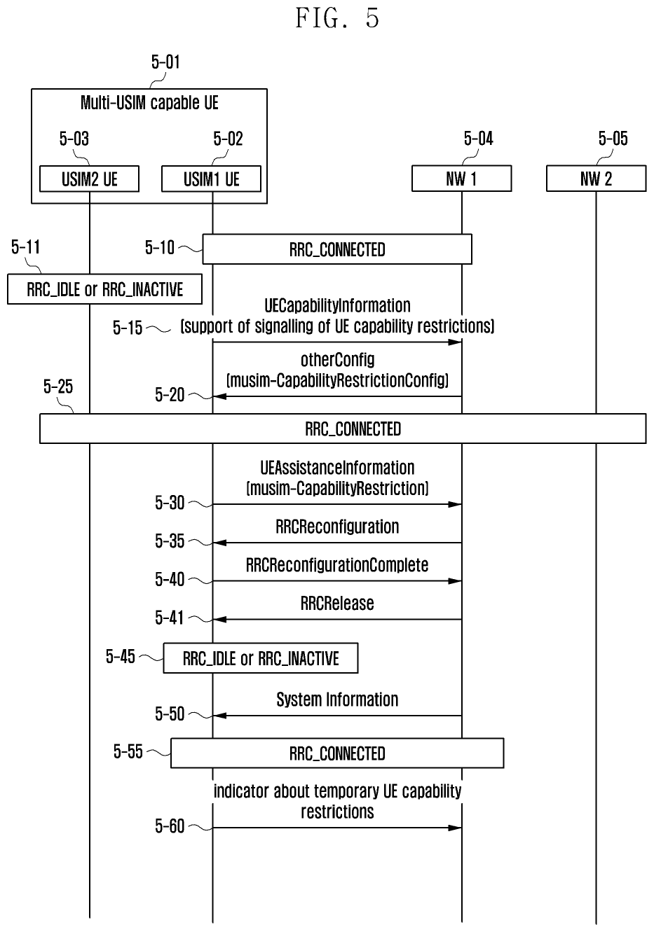

FIG. 5 is a flowchart in which a UE for supporting multiple USIMs requests/provides temporary UE capability information restrictions from/to a base station, according to an embodiment of the disclosure.

Referring to FIG. 5, a MUSIM UE 5-01 may refer to a UE for supporting multiple USIMs in one device, and a network (NW) may refer to a base station. In the disclosure, a dual-USIM UE for supporting two USIMs is considered for convenience of description, but this is for convenience of description and may be equally applied to a UE for supporting two or more USIMs, and this concept may be equally applied to other drawings of the disclosure. For example, the MUSIM UE 5-01 may refer to a USIM 1 UE 5-02 when operating with USIM 1, and refer to a USIM 2 UE 5-03 when operating with USIM 2. In this case, base stations 5-04 and 5-05 associated with respective USIMs may recognize the USIM 1 UE 5-02 and the USIM 2 UE 5-03 as separate UEs rather than the MUSIM UE 5-01 operating in the same device. The USIM 1 UE 5-02 and the USIM 2 UE 5-03 according to an embodiment of the disclosure may share hardware capability of the MUSIM UE 5-01 with each other and use the same. Therefore, when the USIM 1 UE 5-02 and the USIM 2 UE 5-03 simultaneously transmit or receive a signal to or from base station 1 5-04 and base station 2 5-05, UE capabilities of the respective USIM UEs may be temporarily limited by each other.

In operation 5-10, the USIM 1 UE 5-02 may establish an RRC connection with base station 1 5-04 to be in an RRC connected mode (RRC_CONNECTED).

In operation 5-11, the USIM 2 UE 5-03 may be in an RRC idle mode (RRC_IDLE) or an RRC inactive mode (RRC_INACTIVE) without establishing an RRC connection with base station 2 5-05.

In operation 5-15, the USIM 1 UE 5-02 may transmit a UE capability information message (UECapabilityInformation) including capability information of the MUSIM UE 5-01 to base station 1 5-04. The capability of the MUSIM UE 5-01 is static, but the USIM 1 UE 5-02 shares the capability of the MUSIM UE 5-01 with the USIM 2 UE 5-03 and uses the same, and thus the capability of the USIM 1 UE 5-02 may be temporarily restricted according to an operation of the USIM 2 UE 5-03. Therefore, the USIM 1 UE 5-02 may inform base station 1 5-04 of capability information related to such temporary UE capability restrictions by including the capability information in the UE capability information message. Specifically, the message may include at least one of the following pieces of information.
Information on the capability of allowing the USIM 1 UE 5-02 to request or provide detailed temporary UE capability restrictions from or to base station 1 5-04 through a predetermined RRC message (e.g., UEAssistanceInformation)
   The capability of allowing the USIM 1 UE 5-02 to, when the capability of the USIM 1 UE 5-02 is temporarily restricted by the USIM 2 UE 5-03, transmit a predetermined RRC message including specific temporary UE capability restriction information relating thereto to base station 1 5-04, based on a configuration of base station 1 5-04
Information on the capability of allowing the USIM 1 UE 5-02 to preemptively provide information on whether temporary UE capability restrictions exist to base station 1 5-04 through a predetermined RRC message (e.g., includes RRCSetupComplete, RRCResumeComplete, RRCReconfigurationComplete, and RRCReestablishmentComplete, but is not limited thereto)
   The capability of allowing the USIM 1 UE 5-02 to, when the capability of the USIM 1 UE 5-02 is temporarily restricted by the USIM 2 UE 5-03, transmit a predetermined RRC message including an indicator indicating whether temporary capability restrictions relating thereto exist to base station 1 5-04, based on a configuration of base station 1 5-04

In operation 5-20, base station 1 5-04 may transmit a predetermined RRC message (e.g., an RRCReconfiguration message) including configuration information (e.g., musim-CapabilityRestrictionConfig) that allows the USIM1 UE 5-02 to report preferred/required temporary UE capability restriction information to base station 1 5-04. For example, the musim-CapabilityRestrictionConfig may be included in otherConfig. For example, the musim-CapabilityRestrictionConfig may include at least one of the following pieces of information.
Maximum multiple input and multiple output (hereinafter, MIMO) layer restriction request/change configuration information
   A new prohibit timer value or an indicator indicating whether the USIM 1 UE 5-02 is allowed to transmit preferred maximum MIMO layer restriction information to base station 1 5-04 due to a MUSIM operation (for example, the USIM 2 UE 5-03 transitions to an RRC connected mode and then performs data transmission and reception with base station 2 5-05, or transitions from an RRC connected mode to an RRC idle mode or an RRC inactive mode and then performs a necessary operation.)
Measurement gap requirement restriction request/change configuration information
   A new prohibit timer value or an indicator indicating whether the USIM 1 UE 5-02 is allowed to transmit preferred measurement gap requirement restriction information to base station 1 5-04 due to a MUSIM operation
Serving cell or serving cell group release/configuration restriction request configuration information
   A new prohibit timer value or an indicator indicating whether the USIM 1 UE 5-02 is allowed to transmit release request information for a currently configured serving cell (or serving cell group) to base station 1 5-04 due to a MUSIM operation
   Alternatively, a new prohibit timer value or an indicator indicating whether the USIM 1 UE 5-02 is allowed to transmit information not to configure an additional configurable cell or frequency to base station 1 5-04 due to a MUSIM operation
Maximum supportable bandwidth or band combination restriction request/change configuration information
   A new prohibit timer value or an indicator indicating whether the USIM 1 UE 5-02 is allowed to transmit preferred maximum supportable bandwidth or band combination restriction information to base station 1 5-04 due to a MUSIM operation
An indicator indicating whether the USIM 1 UE 5-02 can transition to an RRC connected mode and then preemptively inform base station 1 5-04 of whether temporary UE capability restrictions exist through a predetermined RRC message transmitted to base station 1 5-04 or a predetermined RRC message transmitted in the RRC connected mode

In operation 5-25, the USIM 2 UE 5-03 may establish an RRC connection with base station 2 5-05 to be in an RRC connected mode (RRC_CONNECTED).

In operation 5-30, the USIM 1 UE 5-02 may transmit, to base station 1 5-04, a predetermined RRC message (e.g., UEAssistanceInformation) including temporary UE capability restriction information (musim-CapabilityRestriction) due to the operation of the USIM 2 UE 5-03. For example, the predetermined RRC message may include at least one of the following pieces of temporary UE capability restriction information.
Restriction information on the number of MIMO layers for a serving cell for each frequency range (FR)
   Restriction information on the number of MIMO layers for each uplink or downlink may be separately included.
Restriction information on a measurement gap
Explicit release request information for a serving cell or a serving cell group
Supportable bandwidth or bandwidth combination information
   The above information may be represented for each cell, each frequency, or each carrier.

For reference, in operation 5-30, the USIM 1 UE 5-02 may transmit, to base station 1 5-04, a predetermined RRC message (e.g., UEAssistanceInformation) including temporary UE capability restriction information (musim-Capability Restriction) when at least one of the following conditions is met.
Condition 1: When the predetermined RRC message (e.g., UEAssistanceInformation) including the temporary UE capability restriction information (musim-CapabilityRestriction) has not been transmitted to base station 1 5-04 after musim-CapabilityRestrictionConfig is configured from base station 1 5-04
Condition 2: When the current temporary UE capability restriction information is different from the temporary UE capability restriction information (musim-CapabilityRestriction) most recently transmitted to base station 1 5-04
Condition 3: When the current temporary UE capability restriction information is different from the temporary UE capability restriction information (musim-CapabilityRestriction) most recently transmitted to base station 1 5-04 and a prohibit timer is not running
   Even when particular temporary UE capability restriction information is changed, condition 3 is met, and the UE runs only one prohibit timer.
Condition 4: When the current temporary UE capability restriction information is different from the temporary UE capability restriction information (musim-CapabilityRestriction) most recently transmitted to base station 1 5-04 and a prohibit timer corresponding to the corresponding capability restriction information is not running
   The difference from condition 3 is that the USIM 1 UE 5-02 may determine condition 4 by separately running a prohibit timer for each temporary UE capability restriction feature. Each temporary UE capability restriction feature refers to each piece of information, such as restriction information on the number of MIMO layers and restriction information on a measurement gap.

In operation 5-35, base station 1 5-04 may transmit a predetermined RRC message (e.g., RRCReconfiguration) including RRC configuration information, based on the temporary UE capability restriction information provided by the USIM 1 UE 5-02, in response to operation 5-30. In operation 5-40, the USIM 1 UE 5-02 may transmit a predetermined RRC message (e.g., RRCReconfigurationComplete) to base station 1 5-04 in response to the predetermined RRC message received in operation 5-35.

In operation 5-41, base station 1 5-04 may transmit an RRC connection release message (RRCRelease) to the USIM 1 UE 5-02. When the message includes suspend configuration information (suspendConfig), the USIM 1 UE 5-02 may transition to an RRC inactive mode, otherwise, may transition to an RRC idle mode.

In operation 5-45, the USIM 1 UE 5-02 having received the RRC release message may be in an RRC idle mode or an RRC inactive mode.

In operation 5-50, the USIM 1 UE 5-02 may obtain system information from base station 1 5-04. When the USIM 1 UE 5-02 has temporary UE capability restrictions due to a MUSIM operation (that is, due to the USIM 2 UE 5-03), an indicator indicating whether the UE is allowed to send an indicator indicating the temporary UE capability restrictions to base station 1 5-04 may be broadcast through the system information according to an embodiment of the disclosure. For example, when the above-described indicator is included in the system information, the USIM 1 UE 5-02 may include an indicator indicating that the UE (USIM 1 UE 5-02) has temporary UE capability restrictions in a predetermined RRC message (e.g., RRCSetupComplete, RRCResumeComplete, RRCReconfigurationComplete, and RRCReestablishmentComplete), and transmit the same to base station 1 5-04. Base station 1 5-04 having received the temporary UE capability restriction indicator may not provide RRC configuration information to the USIM 1 UE 5-02, based on the capability of the MUSIM UE 5-01, and may later receive specific temporary UE capability restriction information from the USIM 1 UE 5-02 and then provide the RRC configuration information, based on the specific temporary UE capability restriction information.

In operation 5-55, the USIM 1 UE 5-02 may establish an RRC connection with base station 1 5-04 to be in an RRC connected mode.

In operation 5-60, the USIM 1 UE 5-02 in the RRC connected mode may transmit, to base station 1 5-04, a predetermined RRC message including an indicator indicating whether the UE has temporary UE capability restrictions. The USIM 1 UE 5-02 may transmit, to the base station, a predetermined RRC message including an indicator indicating whether temporary UE capability restrictions exist, based on the received system information. The predetermined RRC message may refer to at least one of the following.
The USIM 1 UE 5-02 transmits an RRCSetupComplete message including the indicator to base station 1 5-04 through an RRC connection establishment procedure.
The USIM 1 UE 5-02 transmits an RRCSetupComplete or RRCResumeComplete message including the indicator to base station 1 5-04 through an RRC connection resume procedure.
The USIM 1 UE 5-02 transmits an RRCSetupComplete or RRCReestablishmentComplete message including the indicator to base station 1 5-04 through an RRC connection reestablishment procedure.
The USIM 1 UE 5-02 transmits an RRCReconfigurationComplete message including the indicator to base station 1 5-04 through an RRC connection reconfiguration procedure.

For reference, when at least one of the following conditions is met, the USIM 1 UE 5-02 may transmit, to base station 1 5-04, a predetermined RRC message including an indicator indicating whether temporary UE capability restrictions exist.
Condition 1: When an indicator indicating whether the USIM1 UE 5-02 is allowed to send information indicating whether temporary UE capability restrictions exist to base station 1 5-04 is broadcast through the system information (operation 5-50), and the USIM 1 UE 5-02 has temporary UE capability restrictions due to the USIM 2 UE 5-03 (or when the USIM 1 UE 5-02 desires to perform the above-described operation 5-30)
Condition 2: When base station 1 5-04 configures, for the USIM 1 UE 5-02, allowance of transmission of whether temporary UE capability restrictions exist, through a predetermined RRC message, and the USIM 1 UE 5-02 has temporary UE capability restrictions due to the USIM 2 UE 5-03 (or when the USIM 1 UE 5-02 desires to perform the above-described operation 5-30)
   The predetermined RRC message may refer to at least one of an RRC connection reconfiguration message (RRCReconfiguration), an RRC connection release message (RRCRelease), an RRC connection setup message (RRCSetup), an RRC connection resume message (RRCResume), and an RRC connection reestablishment message (RRCReestablishment) including otherConfig.

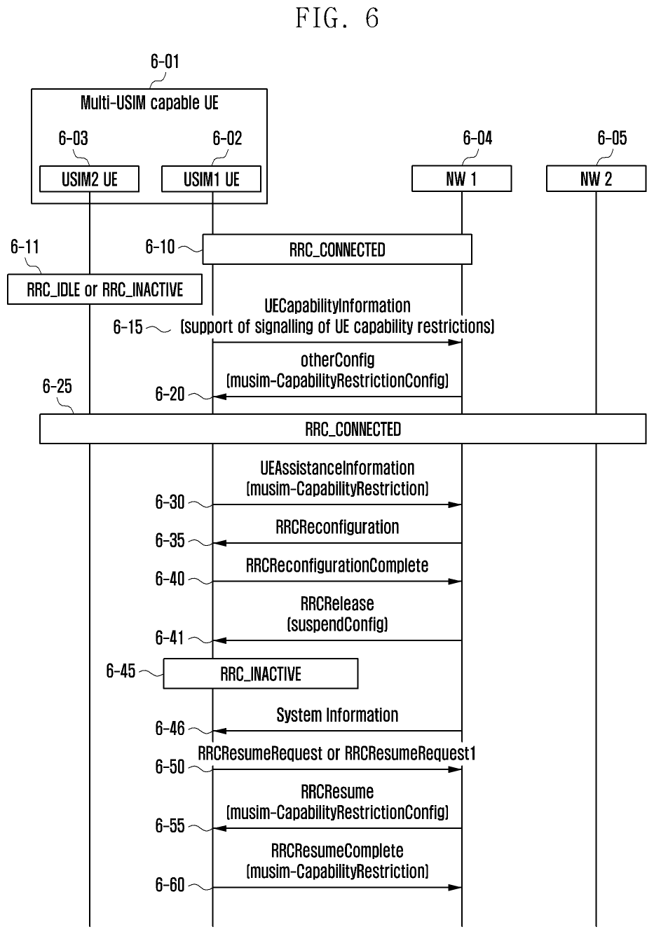

FIG. 6 is a flowchart in which a UE for supporting multiple USIMs requests/provides temporary UE capability information restrictions from/to a base station, according to an embodiment of the disclosure.

In operation 6-10, a USIM 1 UE 6-02 may establish an RRC connection with base station 1 6-04 to be in an RRC connected mode (RRC_CONNECTED).

In operation 6-11, a USIM 2 UE 6-03 may be in an RRC idle mode (RRC_IDLE) or an RRC inactive mode (RRC_INACTIVE) without establishing an RRC connection with base station 2 6-05.

In operation 6-15, the USIM 1 UE 6-02 may transmit a UE capability information message (UECapabilityInformation) including capability information of an MUSIM UE 6-01 to base station 1 6-04. This may follow the above-described embodiment. Additionally, the message may include the following information.
The capability of allowing the USIM 1 UE 6-02 to receive an RRC connection resume message (RRCResume) including musim-Capability RestrictionConfig from base station 1 6-04, and allowing the USIM 1 UE 6-02 to transmit an RRC connection resume complete message (RRCResumeComplete) or a UE assistance information message (UEAssistanceInformation) including musim-Capability Restriction to base station 1 6-04. The reception capability of the UE and the transmission capability of the UE may be respectively indicated, or one piece of information may indicate the reception capability and the transmission capability.

In operation 6-20, base station 1 6-04 may transmit a predetermined RRC message (e.g., an RRCReconfiguration message) including configuration information (musim-CapabilityRestrictionConfig) that allows the USIM1 UE 6-02 to report preferred/required temporary UE capability restriction information to base station 1 6-04. This may follow the above-described embodiment of FIG. 5.

In operation 6-25, the USIM 2 UE 6-03 may establish an RRC connection with base station 2 6-05 to be in an RRC connected mode (RRC_CONNECTED).

In operation 6-30, the USIM 1 UE 6-02 may transmit, to base station 1 6-04, a predetermined RRC message (e.g., UEAssistanceInformation) including temporary UE capability restriction information (musim-CapabilityRestriction) due to the operation of the USIM 2 UE 6-03. This may follow the above-described embodiment of FIG. 5.

In operation 6-35, base station 1 6-04 may transmit a predetermined RRC message (e.g., RRCReconfiguration) including RRC configuration information, based on the temporary UE capability restriction information provided by the USIM 1 UE 6-02, in response to operation 6-30. In operation 6-40, the USIM 1 UE 6-02 may transmit a predetermined RRC message (e.g., RRCReconfigurationComplete) to base station 1 6-04 in response to the predetermined RRC message received in operation 6-35.

In operation 6-41, base station 1 6-04 may transmit an RRC connection release message (RRCRelease) including suspend configuration information (suspendConfig) to the USIM 1 UE 6-02.

In operation 6-45, the USIM 1 UE 6-02 having received the RRC release message may be in an RRC inactive mode.

In operation 6-46, the USIM 1 UE 6-02 may obtain system information.

In operation 6-50, the USIM 1 UE 6-02 may perform an RRC connection resume procedure to transmit an RRC connection resume request message (RRCResumeRequest or RRCResumeRequest1) to base station 1 6-04. The USIM 1 UE 6-02 may not release otherConfig or musim-CapabilityRestrictionConfig stored in UE Inactive AS Context when initiating the RRC connection resume procedure, and whether to release otherConfig or musim-CapabilityRestrictionConfig may be performed in operation 6-60 (e.g., when the corresponding information (e.g., musim-CapabilityRestrictionConfig) is not in an RRC connection resume message (RRCResume)). Alternatively, the USIM1 UE 6-02 may not release otherConfig or musim-CapabilityRestrictionConfig stored in UE Inactive AS Context when the system information received in operation 6-46 includes an indicator indicating that otherConfig or musim-CapabilityRestrictionConfig does not need to be released when initiating the RRC connection resume procedure. For reference, if musim-CapabilityRestrictionConfig is not released, the USIM 1 UE 6-02 may not stop a related prohibit timer when the prohibit timer is also running. This may also be applied to the description described later.

In operation 6-55, base station 1 6-04 may transmit an RRC connection resume message (RRCResume) including musim-CapabilityRestrictionConfig to the USIM 1 UE 6-02.

In operation 6-60, the USIM 1 UE 6-02 may transmit an RRC connection resume complete message (RRCResumeComplete) including musim-Capability Restriction to base station 1 6-04. For example, when the USIM 1 UE 6-02 has temporary UE capability restrictions due to the USIM 2 UE 6-03 (or when the USIM 1 UE 6-02 desires to perform the above-described operation 6-30), the USIM 1 UE 6-02 may perform operation 6-60. The USIM 1 UE 6-02 may transmit an RRC connection resume complete message to the base station and then transmit a UE assistance information message (UEAssistanceInformation) including musim-Capability Restriction to base station 1 6-04, and base station 1 6-04 may perform an RRC connection reconfiguration procedure on the USIM 1 UE 6-02, based on the transmitted message. This refers to reporting of the UE capability information and the RRC connection reconfiguration procedure previously described.

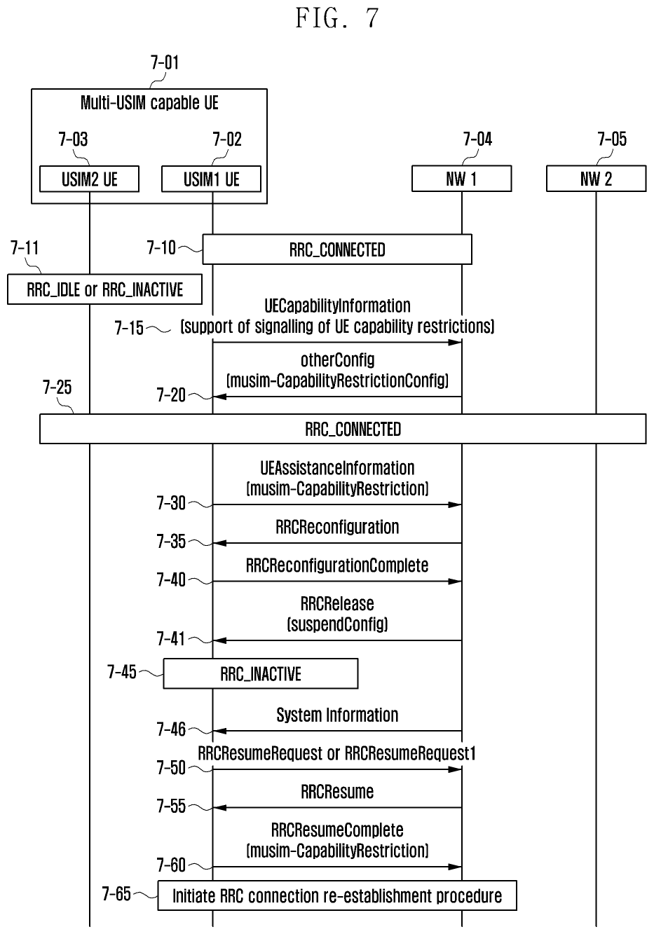

FIG. 7 is a flowchart in which a UE for supporting multiple USIMs requests/provides temporary UE capability information restrictions from/to a base station, according to an embodiment of the disclosure.

In operation 7-10, a USIM 1 UE 7-02 may establish an RRC connection with base station 1 7-04 to be in an RRC connected mode (RRC_CONNECTED).

In operation 7-11, a USIM 2 UE 7-03 may be in an RRC idle mode (RRC_IDLE) or an RRC inactive mode (RRC_INACTIVE) without establishing an RRC connection with base station 2 7-05.

In operation 7-15, the USIM 1 UE 7-02 may transmit a UE capability information message (UECapabilityInformation) including capability information of an MUSIM UE 7-01 to base station 1 7-04. This may follow at least one of the above-described embodiments of FIGS. 5 and 6. Additionally, the message may include the following information.
The capability of allowing the USIM 1 UE 7-02 not to release musim-CapabilityRestrictionConfig when initiating an RRC connection resume procedure or when initiating an RRC connection reestablishment procedure.

In operation 7-20, base station 1 7-04 may transmit a predetermined RRC message (e.g., an RRCReconfiguration message) including configuration information (musim-CapabilityRestrictionConfig) that allows the USIM1 UE 7-02 to report preferred/required temporary UE capability restriction information to base station 1 7-04. This may follow at least one of the above-described embodiments of FIGS. 5 and 6.

In operation 7-25, the USIM 2 UE 7-03 may establish an RRC connection with base station 2 7-05 to be in an RRC connected mode (RRC_CONNECTED).

In operation 7-30, the USIM 1 UE 7-02 may transmit, to base station 1 7-04, a predetermined RRC message (e.g., UEAssistanceInformation) including temporary UE capability restriction information (musim-CapabilityRestriction) due to the operation of the USIM 2 UE 7-03. This may follow at least one of the above-described embodiments of FIGS. 5 and 6.

In operation 7-35, base station 1 7-04 may transmit a predetermined RRC message (e.g., RRCReconfiguration) including RRC configuration information, based on the temporary UE capability restriction information provided by the USIM 1 UE 7-02, in response to operation 7-30. In operation 7-40, the USIM 1 UE 7-02 may transmit a predetermined RRC message (e.g., RRCReconfigurationComplete) to base station 1 7-04 in response to the predetermined RRC message received in operation 7-35.

In operation 7-41, base station 1 7-04 may transmit an RRC connection release message (RRCRelease) including suspend configuration information (suspendConfig) to the USIM 1 UE 7-02.

In operation 7-45, the USIM 1 UE 7-02 having received the RRC release message may be in an RRC inactive mode.

In operation 7-46, the USIM 1 UE 7-02 may obtain system information from base station 1 7-04.

In operation 7-50, the USIM 1 UE 7-02 may initiate an RRC connection resume procedure. The USIM 1 UE 7-02 may not release musim-CapabilityRestrictionConfig stored in UE Inactive AS context. For example, when the USIM 1 UE 7-02 has the capability of maintaining musim-CapabilityRestrictionConfig stored in Inactive AS context without releasing the same, when an indicator indicating to maintain musim-CapabilityRestrictionConfig is broadcast through the system information, or when an indicator indicating to maintain musim-Capability RestrictionConfig stored in Inactive AS context without releasing the same is configured through a predetermined RRC message (e.g., RRCRelease or RRCReconfiguration), the USIM 1 UE 7-02 may not release musim-Capability RestrictionConfig stored in UE Inactive AS context.

In addition, the USIM 1 UE 7-02 may transmit an RRC connection resume request message (RRCResumeRequest or RRCResumeRequest1) to base station 1 7-04 (operation 7-50).

In operation 7-55, base station 1 7-04 may transmit an RRC connection resume message (RRCResume) to the USIM 1 UE 7-02. The message may include musim-CapabilityRestrictionConfig.

In operation 7-60, the USIM 1 UE 7-02 may transmit an RRC connection resume complete message (RRCResumeComplete) including musim-CapabilityRestriction to base station 1 7-04. For example, when the USIM 1 UE 7-02 has temporary UE capability restrictions due to the USIM 2 UE 7-03 (or when the USIM 1 UE 7-02 desires to perform the above-described operation 7-30, the USIM 1 UE 7-02 may perform operation 7-60. The USIM 1 UE 7-02 may transmit an RRC connection resume complete message and then transmit a UE assistance information message (UEAssistanceInformation) including musim-CapabilityRestriction to base station 1 7-04, and base station 1 7-04 may perform an RRC connection reconfiguration procedure on the USIM 1 UE 7-02, based on the transmitted message.

In operation 7-65, the USIM 1 UE 7-02 may perform an RRC connection reestablishment procedure with base station 1 7-04. The USIM 1 UE 7-02 may not release musim-CapabilityRestrictionConfig when initiating the RRC connection reestablishment procedure (may not stop a related prohibit timer when the prohibit timer is also running). For example, the above operation may be performed at the case where attemptCondReconfig is not configured when the USIM 1 UE 7-02 initiates the RRC connection reestablishment procedure or the case where an operation for selecting a suitable NR cell and transmitting an RRC connection reestablishment request message may be performed when a T311 timer is running. The USIM 1 UE 7-02 quickly transmits musim-CapabilityRestriction to base station 1 7-04 through an RRC connection reestablishment complete message or a UE assistance information message, so that base station 1 7-04 may perform an RRC connection reconfiguration procedure on the USIM 1 UE 7-02, based on the transmitted message.

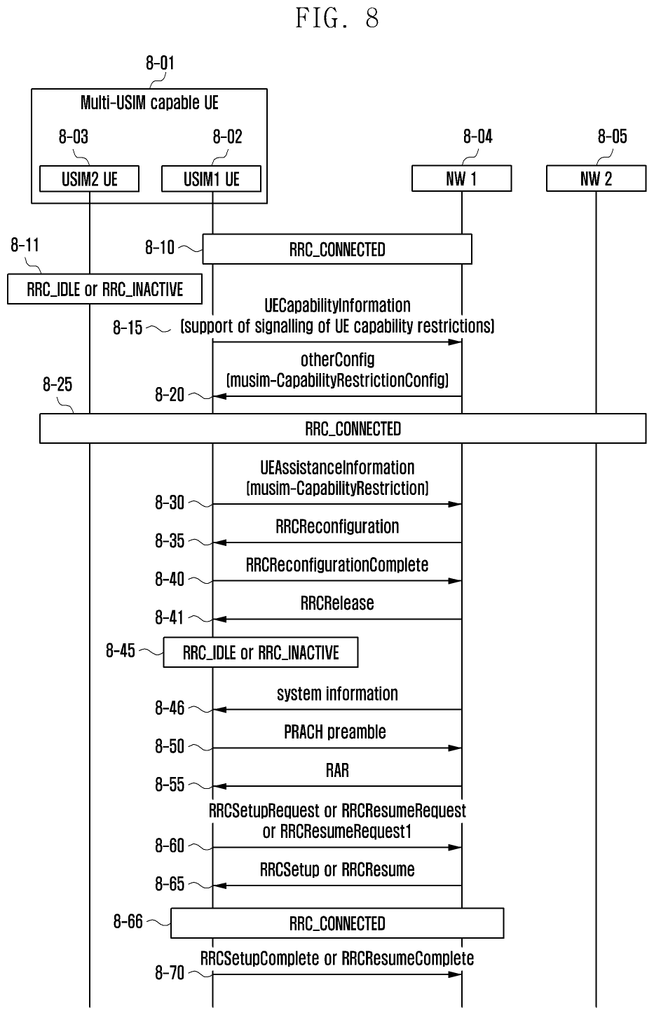

FIG. 8 is a flowchart in which a UE for supporting multiple USIMs requests/provides temporary UE capability information restrictions from/to a base station, according to an embodiment of the disclosure.

In operation 8-10, a USIM 1 UE 8-02 may establish an RRC connection with base station 1 8-04 to be in an RRC connected mode (RRC_CONNECTED).

In operation 8-11, a USIM 2 UE 8-03 may be in an RRC idle mode (RRC_IDLE) or an RRC inactive mode (RRC_INACTIVE) without establishing an RRC connection with base station 2 8-05.

In operation 8-15, the USIM 1 UE 8-02 may transmit a UE capability information message (UECapabilityInformation) including capability information of an MUSIM UE 8-01 to base station 1 8-04. This may follow at least one of the above-described embodiments of FIGS. 5, 6, and 7. Additionally, the message may include at least one of the following pieces of information.
The capability of indicating whether temporary UE capability restrictions exist through a physical random access channel (PRACH) preamble and/or a PRACH occasion
The capability of indicating whether temporary UE capability restrictions exist through each logical channel identifier (logical channel ID, LCID) in a common control channel (CCCH) and CCCH1
The capability of indicating whether temporary UE capability restrictions exist through a spare bit or a cause value defined in an RRC setup request message (RRCSetupRequest) or an RRC resume request message (RRCResumeRequest or RRCResumeRequest1)

In operation 8-20, base station 1 8-04 may transmit a predetermined RRC message (e.g., an RRCReconfiguration message) including configuration information (musim-CapabilityRestrictionConfig) that allows the USIM1 UE 8-02 to report preferred/required temporary UE capability restriction information to base station 1 8-04. This may follow at least one of the above-described embodiments of FIGS. 5, 6, and 7.

In operation 8-25, the USIM 2 UE 8-03 may establish an RRC connection with base station 2 8-05 to be in an RRC connected mode (RRC_CONNECTED).

In operation 8-30, the USIM 1 UE 8-02 may transmit, to base station 1 8-04, a predetermined RRC message (e.g., UEAssistanceInformation) including temporary UE capability restriction information (musim-CapabilityRestriction) due to the operation of the USIM 2 UE 8-03. This may follow at least one of the above-described embodiments.

In operation 8-35, base station 1 8-04 may transmit a predetermined RRC message (e.g., RRCReconfiguration) including RRC configuration information, based on the temporary UE capability restriction information provided by the USIM 1 UE 8-02, in response to operation 8-30. In operation 8-40, the USIM 1 UE 8-02 may transmit a predetermined RRC message (e.g., RRCReconfigurationComplete) to base station 1 8-04 in response to the predetermined RRC message received in operation 8-35.

In operation 8-41, base station 1 8-04 may transmit an RRC connection release message (RRCRelease) to the USIM 1 UE 8-02.

In operation 8-45, the USIM 1 UE 8-02 having received the RRC release message may be in an RRC idle mode or an RRC inactive mode.

In operation 8-46, the USIM 1 UE 8-02 may obtain system information from base station 1 8-04.

The USIM 1 UE 8-02 in the RRC idle mode may initiate an RRC connection establishment procedure with base station 1 8-04 or the USIM 1 UE 8-02 in the RRC inactive mode may initiate an RRC connection resume procedure with base station 1 8-04. Specifically, the USIM 1 UE may transmit a PRACH preamble (Msg 1) to the base station (operation 8-50). In response thereto, the base station may transmit an RAR (Msg 2) to the USIM 1 UE (operation 8-55). The USIM 1 UE may transmit an RRC setup request message (RRCSetupRequest) or an RRC resume request message (RRCResumeRequest or RRCResumeRequest1) (Msg 3) to the base station through a CCCH or CCCH1 (operation 8-60). The base station having received the message may transmit an RRC setup message (RRCSetup) or an RRC resume message (RRCResume) (Msg 4) to the USIM 1 UE (operation 8-65). The USIM 1 UE may transition to an RRC connected mode (operation 8-66) and transmit an RRC setup complete message (RRCSetupComplete) or an RRC resume complete message (RRCResumeComplete) (Msg 5) to the base station in operation 8-70. Such a connection or connection resume operation through a general random access procedure may also be applied to the above-described embodiments of FIGS. 5, 6, and 7. Unlike the above-described embodiments, the USIM 1 UE 8-02 according to an embodiment of the disclosure may inform base station 1 8-04 of whether temporary UE capability restrictions exist by using at least one of the following methods.
Method 1: Through a PRACH preamble and/or a PRACH occasion, the USIM 1 UE 8-02 may inform base station 1 8-04 of whether temporary UE capability restrictions exist. For example, when the USIM 1 UE 8-02 transmits a particular PRACH preamble, base station 1 8-04 may identify that temporary UE capability restrictions exist. A PRACH preamble and/or a PRACH occasion, which are used to indicate whether temporary UE capability restrictions exist, may be provided to the USIM 1 UE through the system information (operation 8-46) or the RRC connection release message (operation 8-41).
Method 2: Through new LCIDs indicated for a CCCH and CCCH1, respectively (two new LCIDs indicated for CCCH and CCCH1, respectively), the USIM 1 UE 8-02 may inform base station 1 8-04 of whether temporary UE capability restrictions exist.
Method 3: Through a spare bit or a cause value defined in an RRC setup request message (RRCSetupRequest) or an RRC resume request message (RRCResumeRequest or RRCResumeRequest 1), the USIM 1 UE 8-02 may inform base station 1 8-04 of whether temporary UE capability restrictions exist.

That is, unlike the above-described embodiments of FIGS. 5, 6, and 7 (informing of whether temporary UE capability restrictions exist through Msg 5), the USIM 1 UE 8-02 according to an embodiment of the disclosure has a feature of informing base station 1 8-04 of whether temporary UE capability restrictions exist through Msg 3 or Msg 1. For reference, by the configuration and indication of base station 1 8-04 (e.g., operation 8-41, operation 8-20, operation 8-40, or operation 8-46), the USIM 1 UE may inform base station 1 8-04 of whether temporary UE capability restrictions exist through Msg 5 according to the above-described embodiments, or may inform base station 1 8-04 of whether temporary UE capability restrictions exist through Msg 3 or Msg 1 according to an embodiment of the disclosure.

Although various embodiments of the disclosure have been described above with reference to FIGS. 5, 6, 7, and 8, this is a division for convenience of description, and the embodiments in the respective drawings can be implemented in combination with each other. Features corresponding to each other in the embodiments in the respective drawings may refer to operations of corresponding features in other embodiments and, for the configurations described with the same message in each embodiment, information included in the same message in other embodiments may be included. For example, in addition to the information included in the UE capability information in FIG. 5, the UE capability information described in FIGS. 6, 7, and 8 may be included in the information of FIG. 5. It is noted that other messages can also be combined within a range that is obvious to a person skilled in the art.

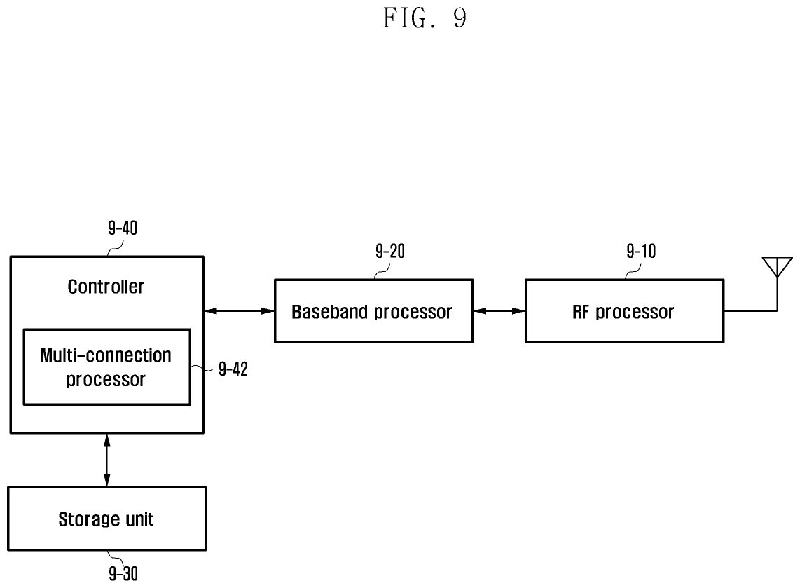

FIG. 9 illustrates a configuration of a UE according to an embodiment of the disclosure.

Referring to FIG. 9, the UE includes a radio frequency (RF) processor 9-10, a baseband processor 9-20, a storage unit 9-30, and a controller 9-40. The controller 9-40 may include a multi-connection processor 9-42. The UE includes a MUSIM UE described in various embodiments of the disclosure.

The RF processor 9-10 performs functions of transmitting or receiving a signal through a wireless channel, such as band conversion and amplification of the signal. That is, the RF processor 9-10 up-converts a baseband signal provided from the baseband processor 9-20 into an RF band signal and then transmits the RF band signal through an antenna, and down-converts the RF band signal received through the antenna into the baseband signal. For example, the RF processor 9-10 may include a transmission filter, a reception filter, an amplifier, a mixer, an oscillator, a digital to analog convertor (DAC), an analog to digital convertor (ADC), and the like. In the drawing, only one antenna is shown, but the UE may include a plurality of antennas. In addition, the RF processor 9-10 may include a plurality of RF chains. Furthermore, the RF processor 9-10 may perform beamforming. For the beamforming, the RF processor 9-10 may adjust a phase and a size of each of signals transmitted or received through the plurality of antennas or antenna elements. In addition, the RF processor may perform MIMO, and may receive multiple layers when performing an MIMO operation.

The baseband processor 9-20 performs a conversion function between a baseband signal and a bit stream according to a physical layer specification of a system. For example, at the time of data transmission, the baseband processor 9-20 generates complex symbols by encoding and modulating transmission bit streams. In addition, at the time of data reception, the baseband processor 9-20 demodulates and decodes a baseband signal provided from the RF processor 9-10 to restore a reception bit stream. For example, according to an orthogonal frequency division multiplexing (OFDM) scheme, at the time of data transmission, the baseband processor 9-20 generates complex symbols by encoding and modulating transmission bit streams and maps the complex symbols to sub-carriers, and then configures OFDM symbols via an inverse fast Fourier transform (IFFT) operation and a cyclic prefix (CP) insertion. In addition, at the time of data reception, the baseband processor 9-20 divides a baseband signal provided from the RF processor 9-10 into the units of OFDM symbols and recovers the signals mapped to the sub-carriers via a fast Fourier transform (FFT) operation, and then restores a reception bit stream via demodulation and decoding.

The baseband processor 9-20 and the RF processor 9-10 transmits and receives a signal as described above. Accordingly, the baseband processor 9-20 and the RF processor 9-10 may be referred to as a transmitter, a receiver, a transceiver, or a communication unit. Furthermore, at least one of the baseband processor 9-20 and the RF processor 9-10 may include a plurality of communication modules in order to support different radio access technologies. In addition, at least one of the baseband processor 9-20 and the RF processor 9-10 may include different communication modules in order to process signals of different frequency bands. For example, the different radio access technologies may include a wireless local area network (LAN) (e.g., IEEE 802.11), a cellular network (e.g., LTE), and the like. In addition, the different frequency bands may include a super high frequency (SHF) (e.g., 2.NRHz, NRhz) band, and a millimeter wave (e.g., 60 GHZ) band.

The storage unit 9-30 stores data such as a basic program, an application program, and configuration information for the operation of the UE. In particular, the storage 9-30 may store information related to a second access node which performs wireless communication by using a second radio access technology. In addition, the storage unit 9-30 provides the stored data according to a request of the controller 9-40.

The controller 9-40 controls the overall operations of the UE. For example, the controller 9-40 transmits or receives a signal through the baseband processor 9-20 and the RF processor 9-10. In addition, the controller 9-40 records and reads data on and from the storage unit 9-30. To this end, the controller 9-40 may include at least one processor. For example, the controller 9-40 may include a communication processor (CP) which performs a control for communication, and an application processor (AP) which controls a higher layer such as an application program. The controller 9-40 may control the operation of the UE according to various embodiments of the disclosure.

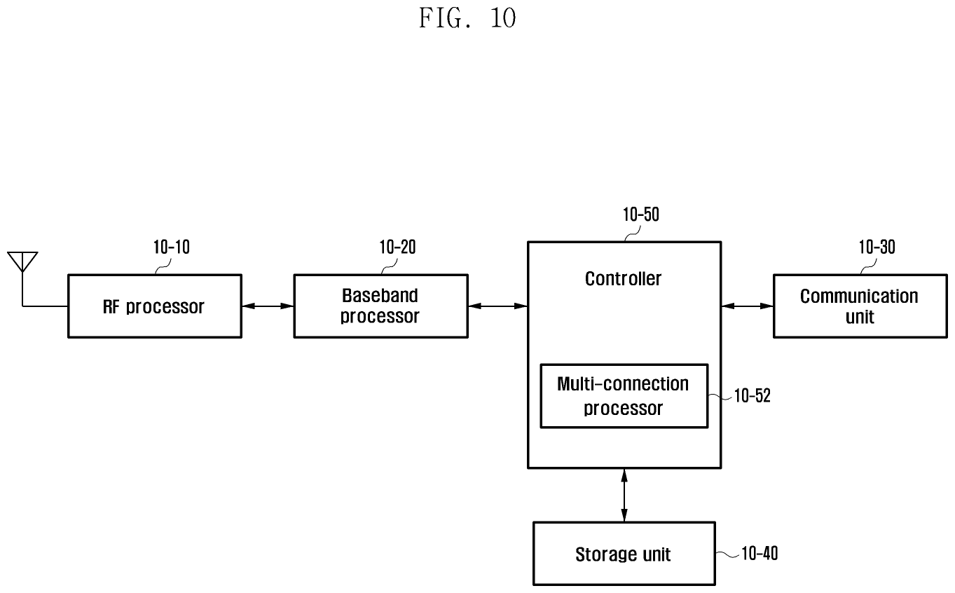

FIG. 10 illustrates a configuration of a base station according to an embodiment of the disclosure.

Referring to FIG. 10, the base station includes an RF processor 10-10, a baseband processor 10-20, a backhaul communication unit 10-30, a storage unit 10-40, and a controller 10-50. The controller 10-50 may further include a multi-connection processor 10-52.

The RF processor 10-10 performs functions of transmitting or receiving a signal through a wireless channel, such as band conversion and amplification of the signal. That is, the RF processor 10-10 up-converts a baseband signal provided from the baseband processor 10-20 into an RF band signal and then transmits the RF band signal through an antenna, and down-converts the RF band signal received through the antenna into the baseband signal. For example, the RF processor 10-10 may include a transmission filter, a reception filter, an amplifier, a mixer, an oscillator, a DAC, an ADC, and the like. In the drawing, only one antenna is shown, but a first access node may include a plurality of antennas. In addition, the RF processor 10-10 may include a plurality of RF chains. Furthermore, the RF processor 10-10 may perform beamforming. For the beamforming, the RF processor 10-10 may adjust a phase and a size of each of signals transmitted or received through the plurality of antennas or antenna elements. The RF processor may perform a downlink MIMO operation by transmitting one or more layers.

The baseband processor 10-20 performs a conversion function between a baseband signal and a bit stream according to a physical layer standard of a first radio access technology. For example, at the time of data transmission, the baseband processor 10-20 generates complex symbols by encoding and modulating transmission bit streams. In addition, at the time of data reception, the baseband processor 10-20 demodulates and decodes a baseband signal provided from the RF processor 10-10 to restore a reception bit stream. For example, according to an OFDM scheme, at the time of data transmission, the baseband processor 10-20 generates complex symbols by encoding and modulating transmission bit streams and maps the complex symbols to sub-carriers, and then configures OFDM symbols via an IFFT operation and a CP insertion. In addition, at the time of data reception, the baseband processor 10-20 divides a baseband signal provided from the RF processor 10-10 into the units of OFDM symbols and recovers the signals mapped to the sub-carriers via an FFT operation, and then restores a reception bit stream via demodulation and decoding. The baseband processor 10-20 and the RF processor 10-10 transmits and receives a signal as described above. Accordingly, the baseband processor 10-20 and the RF processor 10-10 may be referred to as a transmitter, a receiver, a transceiver, a communication unit, or a wireless communication unit.

The backhaul communication unit 10-30 provides an interface for performing communication with other nodes in the network. That is, the backhaul communication unit 10-30 converts a bit stream transmitted from a main base station to another node, for example, an auxiliary base station, a core network, etc. into a physical signal, and converts a physical signal received from the other node into a bit stream.

The storage unit 10-40 stores data such as a basic program, an application program, and configuration information for the operation of the main base station. In particular, the storage unit 10-40 may store information on a bearer assigned to an accessed UE, a measurement result reported from the accessed UE, and the like. In addition, the storage unit 10-40 may store information serving as a standard for determining whether to provide multiple connections to the UE or stop the multiple connections. In addition, the storage unit 10-40 provides the stored data according to a request of the controller 10-50.

The controller 10-50 controls the overall operations of the main base station. For example, the controller 10-50 transmits or receives a signal through the baseband processor 10-20 and the RF processor 10-10 or through the backhaul communication unit 10-30. In addition, the controller 10-50 records and reads data on and from the storage unit 10-40. To this end, the controller 10-50 may include at least one processor. The controller 10-50 may control the operation of the base station according to various embodiments of the disclosure.

Methods according to the embodiments of the disclosure as described in the specification or the claims may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within an electronic device. The one or more programs include instructions that cause the electronic device to execute the methods according to the embodiments of the disclosure as described in the specification or the claims

The programs (software modules and software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other type of optical storage devices, or a magnetic cassette. Alternatively, the programs may be stored in memory configured by a combination of some or all of them. In addition, a plurality of such memories may be included.

In addition, the programs may be stored in an attachable storage device accessible through communication networks such as the Internet, an Intranet, a local area network (LAN), a wide LAN (WLAN), and a storage area network (SAN) or a combination thereof. Such a storage device may access a device which performs an embodiment of the disclosure through an external port. In addition, a separate storage device on a communication network may access the device which performs an embodiment of the disclosure.

In the above-described detailed embodiments of the disclosure, an element included in the disclosure is expressed in the singular or the plural according to the presented detailed embodiments. However, the singular form or plural form is selected appropriately to the presented situation for the convenience of description, and the disclosure is not limited by elements expressed in the singular or the plural. Therefore, an element expressed in the plural may also include a single element or an element expressed in the singular may also include multiple elements.

Meanwhile, the embodiments of the disclosure described in the specification and drawings are merely to provide a specific example to easily describe the technical contents of the disclosure and to help understanding of the disclosure, and are not intended to limit the scope of the disclosure. That is, it is obvious to a person skilled in the art to which the disclosure belongs that other modifications based on the technical idea of the disclosure can be implemented. In addition, each of the above embodiments may be operated in combination with each other as necessary. For example, a base station and a UE may be operated by combining parts of one embodiment of the disclosure and another embodiment thereof. In addition, the embodiments of the disclosure can be applied to other communication systems, and other modifications based on the technical idea of the embodiments can also be implemented.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, system information block 1 (SIB1);
determining whether the UE has a temporary capability restriction; and
in case that the SIB1 comprises information that allows to send an indicator related to the temporary capability restriction, and the UE has the temporary capability restriction, transmitting, to the base station, a first radio resource control (RRC) message including the indicator, wherein the indicator indicates temporary capability restriction associated with multi universal subscriber identity module (MUSIM) operation.

2. The method of claim 1, wherein the UE supports UE capability of reporting the indicator through the first RRC message.

3. The method of claim 1, further comprising:
receiving, from the base station, a second RRC message including configuration information for reporting of UE assistance information;
transmitting, to the base station, the UE assistance information including actual restricted UE capability based on the second RRC message; and
receiving, from the base station, a third RRC message including configuration information based on the UE assistance information.

4. The method of claim 3, wherein, before the third RRC message based on the UE assistance information including the actual restricted UE capability is transmitted from the base station, a configuration of the UE is restricted based on the indicator.

5. The method of claim 3,
wherein the first RRC message is one of an RRC setup complete message, an RRC resume complete message, or an RRC reestablishment complete message,
wherein the configuration information includes band information and prohibit timer information related to an MUSIM, and
wherein the UE assistance information includes MUSIM capability restriction information, and the MUSIM capability restriction information includes multiple input multiple output (MIMO) information, cell-cell group release information, and band information.

6. A method performed by a base station in a wireless communication system, the method comprising:
broadcasting system information block 1 (SIB1); and
in case that the SIB1 includes information that allows to send an indicator related to a temporary capability restriction, and the temporary capability restriction exists for a user equipment (UE), receiving a first radio resource control (RRC) message including the indicator from the UE, wherein the indicator indicates temporary capability restriction associated with multi universal subscriber identity module (MUSIM) operation.

7. The method of claim 6, wherein the UE supports UE capability of reporting the indicator through the first RRC message.

8. The method of claim 6, further comprising:
transmitting, to the UE, a second RRC message including configuration information for reporting of UE assistance information;
receiving, from the UE, the UE assistance information including actual restricted UE capability based on the second RRC message; and
transmitting, to the UE, a third RRC message including configuration information based on the UE assistance information.

9. The method of claim 8, wherein, before the third RRC message based on the UE assistance information including the actual restricted UE capability is transmitted to the UE, a configuration of the UE is restricted based on the indicator.

10. The method of claim 8,
wherein the first RRC message is one of an RRC setup complete message, an RRC resume complete message, or an RRC reestablishment complete message,
wherein the configuration information includes band information and prohibit timer information related to an MUSIM, and
wherein the UE assistance information includes MUSIM capability restriction information, and the MUSIM capability restriction information includes multiple input multiple output (MIMO) information, cell-cell group release information, and band information.

11. A user equipment (UE) in a wireless communication system, the UE comprising:
a transceiver; and
a controller configured to:
receive, from a base station, system information block 1 (SIB1),
determine whether the UE has a temporary capability restriction, and
in case that the SIB1 comprises information that allows to send an indicator related to the temporary capability restriction, and the UE has the temporary capability restriction, transmit, to the base station, a first radio resource control (RRC) message including the indicator, wherein the indicator indicates temporary capability restriction associated with MUSIM operation.

12. The UE of claim 11, wherein the UE supports UE capability of reporting the indicator through the first RRC message.

13. The UE of claim 11, wherein the controller is further configured to:
receive, from the base station, a second RRC message including configuration information for reporting of UE assistance information,
transmit, to the base station, the UE assistance information including actual restricted UE capability based on the second RRC message, and
receive, from the base station, a third RRC message including configuration information based on the UE assistance information.

14. The UE of claim 13, wherein, before the third RRC message based on the UE assistance information including the actual restricted UE capability is transmitted from the base station, a configuration of the UE is restricted based on the indicator.

15. The UE of claim 13,
wherein the first RRC message is one of an RRC setup complete message, an RRC resume complete message, or an RRC reestablishment complete message,
wherein the configuration information includes band information and prohibit timer information related to an MUSIM, and
wherein the UE assistance information includes MUSIM capability restriction information, and the MUSIM capability restriction information includes multiple input multiple output (MIMO) information, cell-cell group release information, and band information.

16. A base station in a wireless communication system, the base station comprising:
a transceiver; and
a controller configured to:
broadcast system information block 1 (SIB1), and
in case that the SIB1 includes information that allows to send an indicator related to a temporary capability restriction, and the temporary capability restriction exists for a user equipment (UE), receive a first radio resource control (RRC) message including the indicator from the UE, wherein the indicator indicates temporary capability restriction associated with multi universal subscriber identity module (MUSIM) operation.

17. The base station of claim 16, wherein the UE supports UE capability of reporting the indicator through the first RRC message.

18. The base station of claim 16, wherein the controller is further configured to:
transmit, to the UE, a second RRC message including configuration information for reporting of UE assistance information,
receive, from the UE, the UE assistance information including actual restricted UE capability based on the second RRC message, and
transmit, to the UE, a third RRC message including configuration information based on the UE assistance information.

19. The base station of claim 18, wherein, before the third RRC message based on the UE assistance information including the actual restricted UE capability is transmitted to the UE, a configuration of the UE is restricted based on the indicator.

20. The base station of claim 18,
wherein the first RRC message is one of an RRC setup complete message, an RRC resume complete message, or an RRC reestablishment complete message,
wherein the configuration information includes band information and prohibit timer information related to an MUSIM, and
wherein the UE assistance information includes MUSIM capability restriction information, and the MUSIM capability restriction information includes multiple input multiple output (MIMO) information, cell-cell group release information, and band information.
